(19) United States
(12) Patent Application Publication
(10) Pub. No.: US 2007/0077946 A1
(43) Pub. Date: Apr. 5, 2007

(54) Cell-specific paging strategy to optimize paging channel usage

(75) Inventors: David S. Benco, Winfield, IL (US); Paresh C. Kanabar, Naperville, IL (US); John C. V. Nguyen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/241,369

(22) Filed: Sep. 30, 2005

(51) Int. Cl. H04Q 7/20

(52) U.S. Cl. 455/458

(57) ABSTRACT

A method is provided for paging a mobile station (40) served by a wireless telecommunications network (A). The method includes: remembering a last known location of the mobile station (40); selecting a paging strategy based upon the last known location of the mobile station (40), the paging strategy defining a number of page attempts and a region to be paged with each attempt; and, selectively paging the mobile station (40) over the wireless telecommunications network (A) in accordance with the selected paging strategy when the mobile station (40) is sought.

### FIELD

The present inventive subject matter relates to the wireless or mobile telecommunications arts. Particular application is found in conjunction with paging a mobile station (MS), and the specification makes particular reference thereto. However, it is to be appreciated that aspects of the present inventive subject matter are also amenable to other like applications.

### BACKGROUND

Wireless or mobile telecommunications networks are generally known in the art. A MS (e.g., a mobile telephone or other mobile or wireless end user device) obtains service and/or access to the wireless network via an over-the-air radio frequency (RF) interface with a base station (BS). Each BS provides the over-the-air interface for and/or serves a particular geographic coverage area known as a cell. Typically, a plurality of base stations are operatively connected to and/or served by a mobile switching center (MSC) that is responsible for routing traffic for a particular MS to the appropriate BS currently serving that MS (i.e., to the cell in which the MS is currently located).

The “mobility” in mobile communications is commonly achieved in part via two communication channels with the MS, namely, a paging channel and an access channel. The paging channel is used to verify and/or establish the location of the MS within the network and to deliver incoming calls to the. MS. The access channel is used by the MS for registration purposes, i.e., to report power-up of the MS, to report changes in the location of the MS, etc.

Typically, a mobile service provider seeks to maximize the number of busy hour call attempts (BHCA) in order to serve an increasing number of mobile subscribers. One obstacle to achieving this goal, however, is the availability of sufficient paging channel bandwidth. While there are known ways to increase paging capacity, they often involve considerable expense and/or lead time, e.g., adding new bandwidth. Accordingly, it is desirable to optimize the usage of existing paging channel bandwidth.

Historically, when an incoming call arrived at a MSC for a MS, all the cells in the entire MSC would be paged in order to find the MS and deliver the call. That is to say, the MSC would signal all the base stations it served to transmit a paging signal over their paging channels to verify or establish the location of the MS within one of the cells. This approach, however, used a considerable amount of paging channel bandwidth insomuch as all the cells within the geographic region served by the MSC where paged for any given instance.

Recent improvements include partitioning the cells served by the MSC into a plurality of zones, i.e., groups of neighboring cells known as location areas (LAs). Another paging region, generally larger than a single LA but smaller than the entire MSC, is commonly known as a LA cluster (LAC), and it typically includes the target LA (i.e., the last known LA of the MS being sought) along with all of its neighboring LAs. Still another paging region known as a customized LAC (CLAC) is disclosed in U.S. patent application Ser. No. 11/065,504, filed Mar. 24, 2005, incorporated by reference herein in its entirety. By seeking or paging a MS in smaller regions (such as an LA, LAC, and/or CLAC) which generally encompass fewer cells than the entire MSC, paging channel bandwidth can be conserved.

However, at times, a single page attempt may not succeed in finding or locating the MS being sought. For example, the MS may be in a cell served by a BS that does not receive the paging instruction or signal from the MSC and accordingly the BS does not broadcast or otherwise transmit the particular page over that cell. Accordingly, for any given instance, the MS being sought is optionally paged a plurality of times until it is located. Commonly, the number of pages attempted is limited to conserve paging channel bandwidth. If the MS is not located in the limited number of pages, then the MSC may simply stop trying to locate the MS.

While using smaller paging regions (e.g., LAs, LACs, CLACs, etc.) can save paging channel bandwidth by relatively decreasing the number of cells paged for any given attempt, the use of smaller paging regions can also adversely impact the page success rate for the MSC. That is to say, with a smaller paging region, it is more likely that the MS being sought will be outside the region being paged and hence the page attempt will fail to locate the MS. Accordingly, the MSC commonly implements a paging strategy that aims to balance the conservation of paging channel bandwidth and the page success rate.

The paging strategy typically designates the number of pages to be attempted and indicates for each successive page attempt which type of paging region should be employed. A generally effective approach for paging a MS is to being paging a small geographic area, and if there is no response, to increase the size of the area that is paged. For example, a paging strategy for a MSC may prescribe three page attempts including: a first page attempt which is made using only the last known LA of the MS being sought; if there is no response from the paged MS to the first attempt, then a second page attempt is made using a LAC or a designated CLAC; and if there is no response from the paged MS to the second attempt, then a third page attempt is made over the entire MSC.

Commonly, the paging strategy employed and/or implemented by the MSC is the same or otherwise uniform across the MSC. That is to say, MSC follows the same defined paging strategy to find or locate the MS regardless of the last known location of the MS. Such a rigid approach, however, assumes that each cell is the same or will behave the same or has the same experiences as every other cell, i.e., the cells are all in essence equal to one another. Nevertheless, in reality, the cells may be quite different from one another and/or unique. For example, from the perspective of the RF environment and/or the geography of the cell, each cell may have significant differences. Moreover, the degree or level of mobility or movement of the mobile stations within the various cells served by the MSC may differ from cell to cell. For example, within the same MSC, there may be a cell that covers an area or part of an area (e.g., a major metropolis) which experiences a high degree of MS mobility or movement, and another cell that covers another area or part of an area (e.g., a university campus) which experiences a low degree of MS mobility or movement. Accordingly, using the same or a uniform paging strategy across the entire MSC can be undesirable and/or disadvantageous is such situations. That is to say, a paging strategy best suited the “high mobility cell” is likely not the same one best suited to the “low mobility cell,” and some compromise in the middle may be less than optimal for both cases.

Accordingly, a new and improved paging system and/or method for a wireless telecommunications network is disclosed that overcomes the above-referenced problems and others.

### SUMMARY

In accordance with one embodiment, a method is provided for paging a mobile station served by a wireless telecommunications network. The method includes: remembering a last known location of the mobile station; selecting a paging strategy based upon the last known location of the mobile station, the paging strategy defining a number of page attempts and a region to be paged with each attempt; and, selectively paging the mobile station over the wireless telecommunications network in accordance with the selected paging strategy when the mobile station is sought.

In accordance with another aspect, a wireless telecommunications network serving a mobile station includes: means for remembering a last known location of the mobile station; means for selecting a paging strategy based upon the last known location of the mobile station, the paging strategy defining a number of page attempts and a region to be paged with each attempt; and, means for paging the mobile station in accordance with the selected paging strategy when the mobile station is sought by the network.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating example embodiments and are not to be construed as limiting. Further, it is to be appreciated that the drawings are not to scale.

FIG. 1 is a diagram illustrating a exemplary telecommunications network suitable for practicing aspects of the present inventive subject matter.

FIG. 2 is a flow chart illustrating an exemplary paging strategy selection process that embodies aspects of the present inventive subject matter.

FIG. 3 is an exemplary paging strategy look-up-table (LUT) that embodies aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components and features that are commonly known in the telecommunications art without further detailed explanation as to their configuration or operation except to the extent they have been modified or altered in accordance with and/or to accommodate the embodiment(s) presented herein.

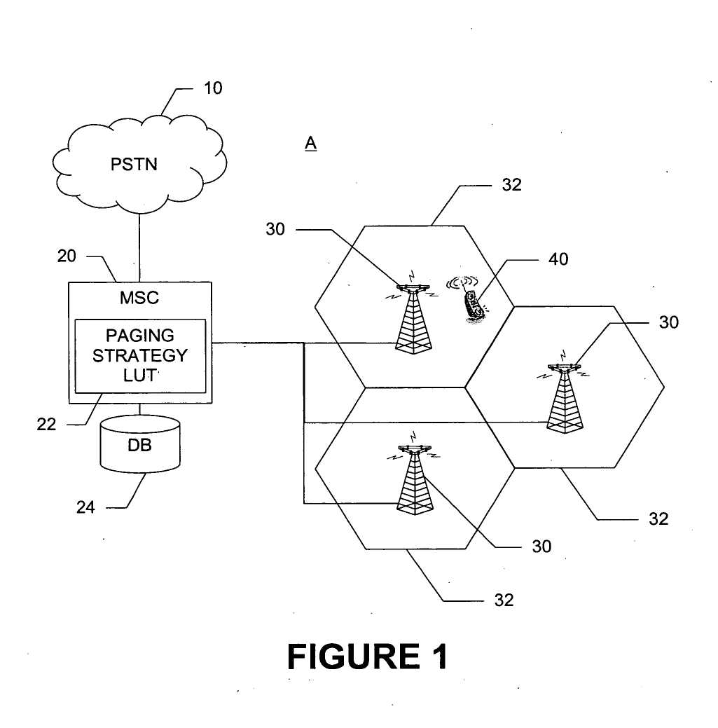

With reference to FIG. 1, a telecommunications network A includes a public switched telephone network (PSTN) 10 operatively connected to and/or in communication with a MSC 20 in the usual manner. The MSC 20 is operatively connected to and/or in communication with a plurality of base stations 30 in the usual manner. As is understood in the art, each BS 30 provides an over-the-air radio frequency interface for its respective geographic area or cell 32. Selectively, a MS (such as the exemplary MS 40 illustrated) is provided telecommunication services and/or otherwise accesses the network A via the interface and/or BS 30 serving the cell 32 in which the MS 40 is located. In the usual manner, two communication channels are selectively employed between the BS 30 and the MS 40, namely, a paging channel and an access channel. The paging channel is used to verify and/or establish the location of the MS 40 within the network A. The access channel is used by the MS 40 for registration purposes, i.e., to report power-up of the MS 40, to report changes in the location of the MS 40, etc.

While only one MSC is illustrated in FIG. 1 for purposes of simplification and clarity, it is to be appreciated that the network A may in fact include any number of one or more MSCs that are similarly situated and/or arranged. Additionally, while three BS 30 and three corresponding cells 32 are illustrated in FIG. 1, it is to be appreciated that more or less than three base stations and/or cells may be similarly situated with respect to any of the one or more MSCs in the network A. That is to say, each MSC in the network A may optionally serve any number of one or more base stations and/or corresponding cells. Additionally, while only one exemplary MS is illustrated in FIG. 1, the network A optionally serves any number of one or more mobile stations similarly situated and/or arranged in any of the one or more cells 32.

Suitably, as the MS 40 travels, it registers its current location with the MSC 20 each time it crosses a defined registration boundary. For example, the MS 40 registers with the MSC 20 serving its location by sending a registration signal to the MSC 20 using the access channel. In this manner, the MSC 20 is able to remember the most recent geographic area from which the MS 40 registered. For example, the MSC 20 may store the last known registration information (including, e.g., the identity of the cell 32 from which the MS 40 last registered) in a location register or database 24.

In addition, the last or most recent cell 32 used to communicate with the MS 40 during a cell access event is also monitored and/or stored by the network A. The identity of this cell 32 is optionally stored or maintained along with and/or as part of the information in the database 24. Cell access events include those events where the MS 40 accesses a cell 32, i.e., the MS 40 sends, receives or otherwise exchanges a transmission to, from or with a BS 30. For example, a cell access event may include, registration of the MS 40, the MS 40 receiving an incoming call, the MS 40 placing an outgoing call, the transmission of packet data to or from the MS 40, receipt or transmittal of a message using short-message-service (SMS), etc. For each of these activities, the network A is able to determine which cell 32 is being used to communicate with the MS 40. Suitably, the identity of this cell 32 is captured and/or updated at each cell access event, e.g., by the MSC 20. A time and/or date stamp for each of these captures and/or updates is also optionally maintained in the database 24. In this manner, it can be determined how old the identity of the last used cell 32 is for the particular MS 40.

When the MS 40 is being sought by the network A (e.g., when an incoming call arrives at the MSC 20 for the MS 40), an appropriate page is sent out for the MS 40 via the paging channel. Optionally, the cells 32 are grouped or otherwise organized into LAs or the like, and the MSC 20 is provisioned with the capability of paging various different regions, e.g., a single cell region, an LA region, a LAC region, a CLAC region or the entire MSC region, with any given page attempt. Suitably, one of a plurality of different paging strategies is selected based upon the last known location of the MS 40, e.g., as recorded in the location register or database 24. Of course, depending upon if and/or when the page is answered, multiple pages may be attempted in accordance with the selected paging strategy. Accordingly, the paging strategy selected and/or implemented by the MSC 20 defines the number of page attempts and the type of paging region to be used for each successive attempt. Notably, the paging strategy selected optionally varies depending upon the last known location or cell 32 of the MS 40 being sought, e.g., as recorded in the location register or database (DB) 24.

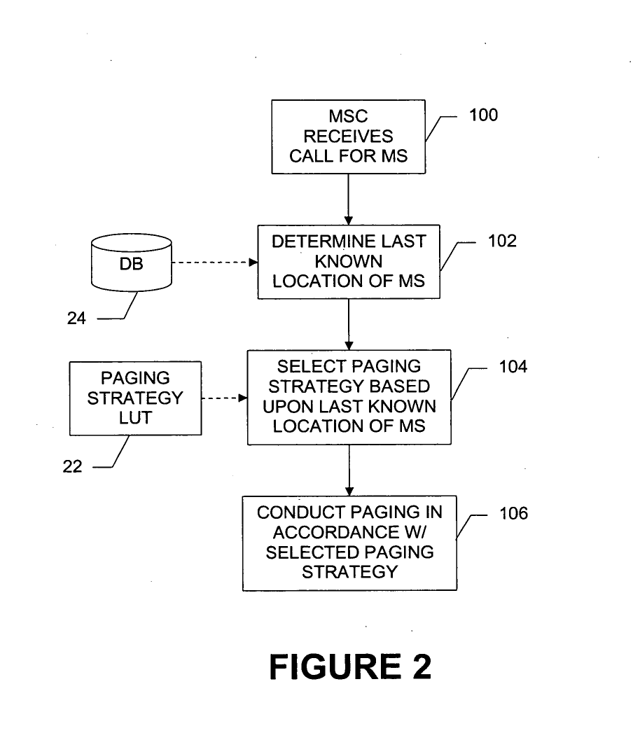

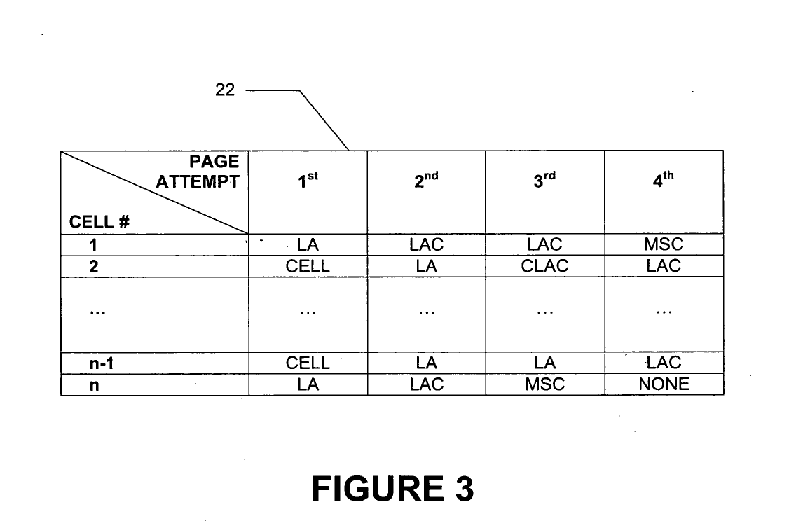

With reference to FIG. 2, operation of an exemplary paging strategy selection process will now be described. The process begins at step 100 with the MSC 20 receiving a call that is, e.g., to be routed to the MS 40. Accordingly, at step 102, the MSC 20 determines the last known location of the MS 40, e.g., by querying the DB 24 to obtain the identity of the cell 32 employed by the MS 40 for its most recent cell access event or registration. At step 104, the MSC selects a specific paging strategy associated with the cell 32 identified in step 102. Suitably, as shown in FIG. 3, different cells 32 served by the MSC 20 optionally have different paging strategies associated therewith. In this manner, the paging strategy selected by the MSC 20 is not always the same or uniform across the MSC region, but rather it depends upon the location or cell 32 in which the sought MS 40 was last observed or detected (e.g., via registration or a cell access event). Finally, at step 106, the MSC 20 administers paging of the MS 40 in accordance with the paging strategy selected in step 104.

Suitably, a plurality of paging strategies are maintained in a look-up-table (LUT), database or the like which is provisioned in or otherwise accessible by the MSC 20. FIG. 3 shows one such exemplary paging strategy LUT 22. In the LUT, DB or the like, each cell 32 served by the MSC 20 is optionally associated with a corresponding paging strategy that is to be used to find the MS 40 when it was last seen or detected in that particular cell 32.

With reference to FIG. 3, cells 1 through n are represented by successive rows in the LUT 22. The paging strategy for each cell 32 is accordingly defined by the particular row corresponding to the cell number or ID. The columns represent successive page attempts within each of the strategies. While four columns are shown in the particular example to represent and/or accommodate up to four page attempts in any given paging strategy, alternately more or less columns may be used in practice to represent and/or accommodate up to some other desired number of page attempts that may be used in any given paging strategy.

At the intersection of each row and column in the LUT 22, the type of paging region to be used in the particular case is designated. More specifically, from the example shown in FIG. 3, the paging strategy associated with cell 1, defines 4 page attempts, i.e., a 1^{st} attempt using an LA region, a 2^{nd} attempt using a LAC region, a 3^{rd} attempt using a LAC region, and a 4^{th} attempt using an entire MSC region. Likewise, the paging strategies associated with cells 2 through n are also defined. Notably, as shown, different cells can be associated with different paging strategies. Suitably, the paging strategies optionally differ in the type of paging region designated for each successive paging attempt. For example, in the paging strategy associated with cell 1, the 1^{st} page attempt is designated for an LA region, while in the paging strategy associated with cell 2, the 1^{st} page attempt is designated for a single cell region. Additionally, as can be appreciated from the example shown in FIG. 3, within any given paging strategy the paging region may or may not change between successive attempts.

The paging strategies are also optionally different in the number of attempts. For example, as shown, the paging strategy associated with cell n includes only three page attempts as opposed to the four page attempts included in the paging strategy associated with cell 1. Note, the entry in the LUT 22 at the intersection of n^{th} row and the 4th column is “NONE” which indicates that there is no 4^{th} attempt in the paging strategy associated with the n^{th} cell.

Optionally, in operation, the MSC 20 consults the LUT 22 to determine which type of paging region to use for any given page. To index the table, the MSC 20 cross references the current page attempt (i.e., selects the appropriate column) with the number or identity of a cell (i.e., selects the appropriate row). Suitably, the cell number or identity used to index the row of the LUT 22 is the same one recorded in the DB 24 for the particular MS 40 being sought, i.e., the last known cell in which the MS 40 was observed or detected (e.g., via a cell access event or registration). The type of paging region designated or entered at the intersection of the indexed row and column is then used to perform the page.

Of course, while some cells 32 are associated with different paging strategies, optionally, other cells 32 may be associated with the same paging strategies. In such a case, cells associated with the same paging strategy may be grouped or otherwise collected together so as to index the same row within the LUT 22; or alternately, the cells may still index separate rows, but the strategies reflected in each of the separate rows may be the same.

Optionally, the paging strategies and/or the LUT 22 are selectively configurable, e.g., by a wireless service provider (WSP) or other operator of the MSC 20. For example, the WSP may optionally enter the particular types of paging regions at different locations in the LUT 22 to define desired paging strategies for the various different cells represented; they may optionally determine or set the number of columns to accommodate up to a desired number of page attempts; they may group cell numbers or IDs together or ranges of cell numbers or IDs together in a common row when the same paging strategy is to be associated with all of them; and/or they may otherwise manipulate the LUT 22 or the plurality of paging strategies represented therein to achieve a desired overall paging protocol that accounts for various differences among the cells 32 supported by the MSC 20. In any event, it is to be appreciated that the selection of a particular paging strategy from a plurality of optionally different paging strategies is based upon the last known location or cell of the sought MS.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for paging a mobile station served by a wireless telecommunications network, the method comprising:
(a) defining a plurality of distinct paging strategies prior to seeking a mobile station within the wireless telecommunication network, each paging strategy setting a number of page attempts to be carried out successively until the sought mobile station is located and a region to be paged with each successive attempt;
(b) storing the plurality of distinct paging strategies;
(c) remembering a last known location of the mobile station;
(d) selecting one paging strategy from the plurality of stored paging strategies based upon the last known location of the mobile station; and,
(e) selectively paging the mobile station over the wireless telecommunications network in accordance with the selected paging strategy when the mobile station is being sought.

2. The method of claim 1, wherein the plurality of distinct paging strategies includes:
at least a first paging strategy and a second paging strategy that are different from one another.

3. The method of claim 2, wherein the difference between the first and second paging strategies is in the number of page attempts set by each.

4. The method of claim 2, wherein the difference between the first and second paging strategies is in the region to be paged for a particular attempt.

5. The method of claim 1, wherein the wireless telecommunications network comprises a plurality of cells among which the mobile station is free to roam, and the last known location of the mobile station is the last known cell in which the mobile station was located.

6. The method of claim 5, wherein step (c) comprises:
monitoring for a communication exchanged between the mobile station and the wireless telecommunications network; and,
recording an identity of the cell used for the communication.

7. A wireless telecommunications network serving a mobile station, said network comprising:
means for storing a plurality of distinct paging strategies, each paging strategy defining a number of page attempts to be carried out successively until a sought mobile station is located within the network and a region to be paged with each successive attempt;
means for remembering a last known location of the mobile station;
means for selecting one paging strategy from the plurality of stored paging strategies based upon the last known location of the mobile station; and,
means for paging the mobile station in accordance with the selected paging strategy when the mobile station is sought by the network.

8. The network of claim 7, wherein the means for remembering includes a location register in which is maintained the last known location of the mobile station.

9. The network of claim 7, wherein the means for selecting includes a mobile switching center, said mobile switching center being operatively connected to a plurality of base stations serving a corresponding plurality of distinct geographic cells.

10. The network of claim 9, wherein means for remembering comprises:
means for monitoring for a communication exchanged between the mobile station and the network; and,
means for recording an identity of the cell used for the communication.

11. The network of claim 9, wherein the means for paging includes the plurality of base stations, each of said base stations supporting an over-the-air interface having a paging channel.

12. The network of claim 11, wherein the mobile switching center administers the selected paging strategy such that in accordance therewith selected ones of said base stations provide paging signals to their corresponding cells via the paging channel of their over-the-air interfaces.

13. The network of claim 7, wherein the plurality of paging strategies includes at least a first paging strategy and a second paging strategy that are different from one another.

14. The network of claim 13, wherein the difference between the first and second paging strategies is in the number of page attempts they define.

15. The network of claim 13, wherein the difference between the first and second paging strategies is in the region to be paged for a particular attempt.

16. The network of claim 7, wherein the means for storing is selected from one of a look-up-table and a database.
